(19) United States
(12) Patent Application Publication
(10) Pub. No.: US 2026/0322473 A1
(43) Pub. Date: Oct. 15, 2026

(54) Method of Configuring a Multi-antenna Transmitter and Receiver Arrangement, a Computer Program Product, a Non-transitory Computer-Readable Storage Medium, a Multi-Antenna Transmitter and Receiver Arrangement, and a Transceiver Node

(71) Applicant: BEAMMWAVE AB, Lund (SE)

(72) Inventors: Joakim Axmon, Limhamn (SE); Bengt Lindoff, Bjärred (SE)

(21) Appl. No.: 19/107,472

(22) PCT Filed: Aug. 16, 2023
(86) PCT No.: PCT/SE2023/050826

§ 371 Date: Feb. 27, 2025

(30) Foreign Application Priority Data
Aug. 29, 2022 (SE) 2230272-3

(51) Int. Cl. H04B 7/08; H04B 7/06

(52) U.S. Cl. CPC H04B 7/086; H04B 7/0617

(57) ABSTRACT

A method for a multi-antenna transmitter and receiver arrangement, MATARA, the MATARA comprisable in a transceiver node, TNode, the method comprising: obtaining first and second channel characteristics for a radio channel between a first remote TNode and the MATARA; starting a first timer, the first timer expiring at the end of a first duration following the start of the first timer; upon reception of an indication that a communication with the first remote TNode is to be performed checking if the first timer has expired; if the first timer has expired, configuring the MATARA based on the second channel characteristics; and if the first timer is still running, configuring the MATARA based on the first and second channel characteristics. Corresponding computer program product, multi-antenna transmitter and receiver arrangement, and transceiver node are also disclosed.

### TECHNICAL FIELD

A method of configuring a multi-antenna transmitter and receiver arrangement, a computer program product, a non-transitory computer-readable storage medium, a multi-antenna transmitter and receiver arrangement, and a transceiver node.

The present disclosure relates to a method of configuring a multi-antenna transmitter and receiver arrangement, a computer program product, a non-transitory computer-readable storage medium, a multi-antenna transmitter and receiver arrangement, and a transceiver node.

More specifically, the disclosure relates to a method of configuring a multi-antenna transmitter and receiver arrangement, a computer program product, a non-transitory computer-readable storage medium, a multi-antenna transmitter and receiver arrangement, and a transceiver node as defined in the introductory parts of the independent claims.

### BACKGROUND ART

In 5G a base station, i.e., a gNodeB (gNB), may need to manage multiple pieces of user equipment (UE) connected to the gNB. A Scheduler is normally used to handle scheduling of data packets to and from a UE. Scheduling is typically a higher layer functionality, i.e., a functionality which is handled above the physical layer, such as at the Medium Access (MAC) layer or at the radio resource control (RRC) layer.

Millimetre wave (mmW) communication between a gNB and a UE is normally made using multi-antenna transceiver arrangements in order to beamform the radio signal, thereby overcoming or mitigating deficiencies in path loss and signal blocking occurring at mmW radio frequencies.

Such beamforming (BF) can be made either as analog, digital or hybrid beamforming, depending on where in relation to the transceiver utilized the BF is performed. Digital BF can handle multiple paths and hence can improve performance especially in the power-limited uplink transmission. BF and control thereof are typically physical (PHY) layer, i.e., lower layer, functionalities.

Many gNB architectures, such as gNBs designed based on the Open Radio Access Network (O-RAN) standard may comprise different units, wherein the physical layer processing is performed by a unit(s) (at PHY layer level) close to the radio unit and wherein the higher layer processing (e.g., data packet scheduling) is performed in a unit(s) further away from the radio unit (i.e., at a higher layer level) and a standardized interface is typically defined for the communication between the lower (physical) layer and higher layer units.

However, such a standardized interface may not support cross-layer interaction between a scheduler and a beamforming unit required for improved or optimized performance of mmW beamforming. As an example, the scheduling of time instances for transmission of data to a certain UE are decided in the MAC layer whereas the PHY layer have the best knowledge of the current radio signal conditions, such as variations in the angle of arrival and angle of direction of signals, from the UE. Thus, cross-layer inter-action between the MAC and PHY layers could improve performance/capacity.

Therefore, there may be a need for methods and apparatuses improving performance/capacity, e.g., by utilizing cross-layer inter-action. Furthermore, there may be a need for reduced power consumption and/or reduced complexity of the system.

WO 2017/026794 A1 discloses that channel information is used to determine beamforming weights. However, WO 2017/026794 A1 is silent regarding cross-layer inter-action and how to reduce complexity.

### SUMMARY

An object of the present disclosure is to mitigate, alleviate or eliminate one or more of the above-identified deficiencies and disadvantages in the prior art and solve at least the above-mentioned problem.

According to a first aspect there is provided a method for a multi-antenna transmitter and receiver arrangement, MATARA, the MATARA comprisable in a transceiver node, TNode, the method comprising: obtaining first and second channel characteristics for a radio channel between a first remote TNode and the MATARA; starting a first timer, the first timer expiring at the end of a first duration following the start of the first timer; upon reception of an indication that a communication with the first remote TNode is to be performed checking if the first timer has expired; if the first timer has expired, configuring the MATARA based on the second channel characteristics; and if the first timer is still running, configuring the MATARA based on the first and second channel characteristics.

According to some embodiments, the first channel characteristics is associated with a first set of channel taps, and the second channel characteristics is associated with a second set of channel taps, and the first set of channel taps comprises more channel taps than the second set of channel taps.

According to some embodiments, one or more channel taps of the second set of channel taps are included in the first set of channel taps and one or more of the channel taps of the first set of channel taps are not included in the second set of channel taps.

According to some embodiments, the method further comprises setting the first duration of the first timer based on a reliability measure of the first and/or second channel characteristics.

According to some embodiments, the reliability measure of the first and/or second channel characteristics is an angle of arrival, AoA, or an angle of departure, AoD, time variation measure.

According to some embodiments, the steps of obtaining, starting, checking, configuring (150), configuring (160) and optionally setting are performed by a physical, PHY, layer control/processing unit, such as a baseband, BB, processor, and the indication that a communication with the first remote TNode is to be performed is received from a media access control, MAC, layer unit or from a radio resource control, RRC, layer unit, such as a higher layer processing unit.

According to some embodiments, the method further comprises: obtaining third and fourth channel characteristics for a radio channel between a second remote TNode and the MATARA; optionally setting a second duration of a second timer based on a reliability measure of the third and/or fourth channel characteristics; starting the second timer, the second timer expiring at the end of the second duration following the start of the second timer; upon reception of an indication that a communication with the second remote TNode is to be performed checking if the second timer has expired; if the second timer has expired, configuring (155) the MATARA based on the fourth channel characteristics; and if the second timer is still running, configuring (165) the MATARA based on the third and fourth channel characteristics.

According to some embodiments, the steps of obtaining, starting, checking, configuring (155), configuring (165) and optionally setting are performed by a physical, PHY, layer control/processing unit, such as a baseband, BB, processor, and the indication that a communication with the second remote TNode is to be performed is received from a media access control, MAC, layer unit or from a radio resource control, RRC, layer unit, such as a higher layer processing unit.

According to some embodiments, the first remote TNode is a first wireless device, WD, and the method further comprises checking if the first WD is connected to the MATARA; if the first WD is not connected to the MATARA erase the identity, ID, of the first WD and the associated first and second radio channel characteristics; and if the first WD is connected to the MATARA leave the memory intact.

According to some embodiments, checking comprises checking if information related to a disconnection of the first WD has been received from a scheduler.

According to some embodiments, checking comprises: optionally setting a third duration of a third timer; starting the third timer, the third timer expiring at the end of the third duration following the start of the third timer; checking if the third timer has expired; if the third timer has expired, regarding the first WD as not connected; and if the third timer is still running, regarding the first WD as connected.

According to a second aspect there is provided a program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a multi-antenna transmitter and receiver arrangement, MATARA, comprising controlling circuitry configured to cause: obtainment of first and second channel characteristics for a radio channel between a first remote TNode and the MATARA; starting of a first timer, the first timer expiring at the end of a first duration following the start of the first timer; upon reception of an indication that a communication with the first remote TNode is to be performed checking of whether the first timer has expired; if the first timer has expired, configuration of the MATARA based on the second channel characteristics; and if the first timer is still running, configuration of the MATARA based on the first and second channel characteristics.

According to a fifth aspect there is provided a transceiver node, TNode, comprising a multi-antenna transmitter and receiver arrangement, MATARA, and controlling circuitry configured to cause: obtainment of first and second channel characteristics for a radio channel between a first remote TNode and the MATARA; starting of a first timer, the first timer expiring at the end of a first duration following the start of the first timer; upon reception of an indication that a communication with the first remote TNode is to be performed checking of whether the first timer has expired; if the first timer has expired, configuration of the MATARA based on the second channel characteristics; and if the first timer is still running, configuration of the MATARA based on the first and second channel characteristics.

According to a sixth aspect there is provided a chip. The chip comprises the MATARA of the fourth aspect and/or a physical, PHY, layer control/processing unit.

Effects and features of the second, third, fourth, fifth, and sixth aspects are fully or to a large extent analogous to those described above in connection with the first aspect and vice versa. Embodiments mentioned in relation to the first aspect are fully or largely compatible with the second, third, fourth, fifth, and sixth aspects and vice versa.

An advantage of some embodiments is that the capacity of a wireless communication system is improved/increased (e.g., optimized).

Another advantage of some embodiments is a reduced power consumption for reception and/or transmission of data.

Yet another advantage of some embodiments is that robustness (of the communication) is improved/increased.

A further advantage of some embodiments is that performance, e.g., uplink and/or downlink performance, is improved or optimized.

Yet a further advantage of some embodiments is that complexity (of the implementation) is reduced (or minimized).

Yet another further advantage of some embodiments is that implementation is simplified and/or that pinging/messaging is reduced.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Furthermore, the term “configured” or “adapted” is intended to mean that a unit or similar is shaped, sized, connected, connectable, programmed or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a schematic drawing illustrating method steps according to some embodiments;

FIG. 1B is a schematic drawing illustrating a multi-antenna transmitter and receiver arrangement according to some embodiments;

FIG. 2 is a flowchart illustrating method steps implemented in a transceiver node, in a multi-antenna transmitter and receiver arrangement, or in a control unit/controlling circuitry thereof, according to some embodiments;

FIG. 3 is a schematic drawing illustrating a computer readable medium according to some embodiments;

FIG. 4 is a schematic drawing illustrating an example base station (gNodeB) architecture according to some embodiments;

FIG. 5 is a schematic timing diagram illustrating scheduling of first and second wireless devices according to some embodiments;

FIG. 6 is a schematic drawing illustrating an example base station (gNodeB) architecture according to some embodiments; and

FIG. 7 is a schematic drawing illustrating method steps according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, tablets, laptops, wireless stations, relays, repeater devices, reconfigurable intelligent surfaces, and large intelligent surfaces.

Below is referred to a “transceiver node” (TNode). A TNode may be a radio unit (RRU), a repeater, a wireless node, or a base station (BS), such as a radio base station (RBS), a Node B, an Evolved Node B (eNB) or a gNodeB (gNB). Furthermore, a TNode may be a BS for a neighbouring cell, a BS for a handover (HO) candidate cell, a radio unit (RRU), a distributed unit (DU), another WD (e.g., a remote WD) or a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

Herein is referred to millimetre Wave (mmW) utilization, mmW communication, mmW communication capability and mmW frequency range. The mmW frequency range is from 24.25 Gigahertz (GHz) to 71 GHz or more generally from 24 to 300 GHz. MmW may also be referred to as Frequency Range 2 (FR2).

Below is referred to a processing unit. The processing unit may be a digital processor. Alternatively, the processor may be a microprocessor, a microcontroller, a central processing unit, a co-processor, a graphics processing unit, a digital signal processor, an image signal processor, a quantum processing unit, or an analog signal processor. The processing unit may comprise one or more processors and optionally other units, such as a control unit.

Below is referred to a digital interface. A digital interface is a unit converting analog signals from e.g., transceivers to digital signals, which digital signals are conveyed to e.g., a baseband processor, and/or converting digital signals from e.g., a baseband processor to analog signals, which analog signals are conveyed to e.g., one or more transceivers. A digital interface possible also comprises filters and other pre-processing functions/units.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports.

Herein is referred to a “filter”. A filter is a device or process that removes some features, components, or frequencies from a signal.

Herein is referred to “analog beamforming”, “hybrid beamforming” and “digital beamforming”. Digital beamforming means that the beamforming processing, e.g., multiplication of a coefficient, is performed before digital to analog conversion (DAC) for transmission (and after analog to digital conversion, ADC, for reception), i.e., in the digital domain. Analog beamforming means that the beamforming processing, e.g., phase shifting, is performed after DAC for transmission (and before ADC for reception), i.e., in the analog domain. Hybrid beamforming means that some beamforming processing, e.g., phase shifting, is performed after DAC and some beamforming processing, e.g., multiplication of a coefficient, is performed before DAC for transmission (and before and after ADC for reception), i.e., processing in both digital and analog domains.

Below is referred to a chip. A chip is an integrated circuit (chip) or a monolithic integrated circuit (chip) and may also be referred to as an IC, or a microchip.

### Basic Concept

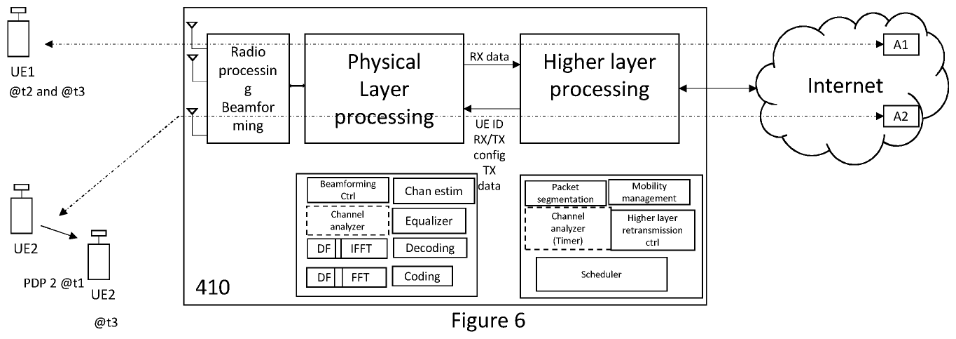

A basic concept of the invention is a processor, such as a baseband (BB) processor (comprisable in a TNode) performing the physical (PHY) layer processing and comprising a channel/beamforming analyser and/or a higher layer processing unit (comprisable in a TNode) performing higher layer processing, such as scheduling, comprising a channel/beamforming analyser as explained in more detail below in connection with FIG. 6. Another basic concept of the invention is that each time a signal is received at the TNode from a WD, the channel characteristics comprising first, such as non-line of sight (nLoS), and second, such as line of sight (LoS), channel characteristics for a radio channel (for the WD; between the WD and the TNode) is obtained by the channel analyser. Furthermore, a first timer is started and upon reception of an indication that a communication with (e.g., transmission to) the remote TNode is to be performed, it is checked whether the first timer has expired. If the first timer has expired, a multi-antenna transmitter and receiver arrangement (MATARA) comprised in the TNode is configured based on the second channel characteristics (and not based on the first channel characteristics), whereas if the first timer is still running, the MATARA is configured based on the first and second channel characteristics. If the first timer has expired, the first channel characteristics is (typically/likely) not valid any longer and should therefore not be utilized for configuration of the MATARA.

### Embodiments

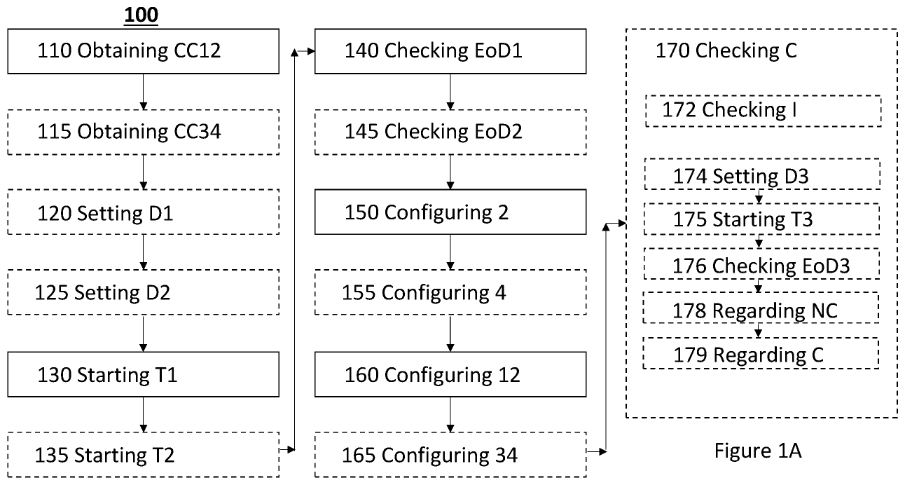

In the following, embodiments will be described where FIG. 1A illustrates method steps according to some embodiments and FIG. 1B illustrates a multi-antenna transmitter and receiver arrangement (MATARA) according to some embodiments. The method 100 is for a multi-antenna transmitter and receiver arrangement (MATARA) 420. Furthermore, the MATARA 420 is comprisable or comprised in a wireless device (WD) or in a transceiver node (TNode), i.e., in some embodiments a WD/TNode 410 comprises the MATARA 420. The method 100 comprises obtaining 110 first and second channel characteristics for a radio channel between a first remote TNode 802, 806 and the MATARA 420. The first and second channel characteristics are in some embodiments, first and second radio channel characteristics, such as first and second spatio-temporal radio channel characteristics. Furthermore, in some embodiments, the first channel characteristics is non-line of sight (nLoS) channel characteristics, i.e., relates to nLoS paths and the second channel characteristics is line of sight (LoS) channel characteristics, i.e., relates to LoS paths. Alternatively, the first channel characteristics comprises first nLoS channel characteristics having a low reliability measure (i.e., non-stable nLoS channel characteristics) and the second channel characteristics comprises second nLoS channel characteristics having a high reliability measure (i.e., stable nLoS channel characteristics) and LoS channel characteristics. In some embodiments, the first nLoS channel characteristics have a reliability measure lower than a reliability measure threshold and the second nLOS channel characteristics have a reliability measure higher than the reliability measure threshold. Furthermore, in some embodiments, all of the nLoS channel characteristics having a reliability measure lower than a reliability measure threshold is included in the first nLOS channel characteristics and all of the nLoS channel characteristics having a reliability measure higher than a reliability measure threshold is included in the second nLoS channel characteristics, i.e., the first nLoS channel characteristics is different from the second nLoS channel characteristics. In some embodiments, the first and second channel characteristics comprise information such as a power delay profile, angle of arrival (or angle of direction) of the incoming (outgoing) radio channel. In some embodiments, the second channel characteristics comprises more reliable radio paths than the first channel characteristics. All the information (e.g., all channel characteristics) may be obtained by a channel estimator unit in a PHY layer processor and/or by a channel analyser/beamforming analyser unit comprised in either the PHY layer processor or in a higher layer processing unit, such as a MAC layer (processing) unit or an RRC layer (processing) unit.

In some embodiments, the method 100 comprises setting a first duration of a first timer based on statistics, such as reliability statistics, such as a reliability measure of the first and/or second channel characteristics. Statistics, such as reliability statistics, e.g., a reliability measure, may be obtained from current and/or historically (e.g., one or more previously) obtained first and/or second channel characteristics. Alternatively, the first duration of the first timer is pre-set or has a default value, such as 1-20 milliseconds (ms), e.g., 5 ms. Furthermore, the method 100 comprises starting 130 the first timer. The first timer is started at the earliest directly after the first and second characteristics has been obtained. The first timer is started at the latest when an analysis of the channel (i.e., the radio channel between the first remote TNode 802, 806 and the MATARA 420) is completed. In some embodiments, the first timer is started when the channel is updated (or immediately/just after). The first timer expires at the end of the first duration. The first duration follows (directly after) the start of the first timer, i.e., the start of the first duration occurs at the same time as the start of the first timer. Moreover, the method 100 comprises checking 140 if the first timer has expired, i.e., checking if the end of the first duration has been reached. The checking 140 is performed upon (at, just after, immediately after) reception of an indication that a communication with (e.g., a transmission to) the first remote TNode 802, 806 is to be performed. The method 100 comprises configuring 150 the MATARA 420 based on the second channel characteristics (only; i.e., without basing the configuring 150 on the first channel characteristics) if the first timer has expired. Furthermore, the method 100 comprises configuring 160 the MATARA 420 based on the first and second channel characteristics if the first timer is still running. In some embodiments, the first channel characteristics is associated with a first set of channel taps and/or spatial directions and the second channel characteristics is associated with a second set of channel taps and/or spatial directions. In some embodiments, the first set of channel taps comprises more channel taps than the second set of channel taps. Alternatively, or additionally, the first set of spatial directions comprises more spatial directions than the second set of spatial directions. In some embodiments, one or more channel taps of the second set of channel taps are included in the first set of channel taps and one or more of the channel taps of the first set of channel taps are not included in the second set of channel taps. Thus, in these embodiments, there is a partial overlap between the first and second sets of channel taps. Alternatively, there is no overlap between the first and second sets of channel taps. As yet another alternative, there is a complete overlap between the first and second sets of channel taps. The configuring 150, 160 (and 155, 165 explained below) may involve/comprise configuring pre-coding/beamforming weights for transmission, reception or for both reception and transmission. Furthermore, the pre-coding/beamforming weights may be implemented utilizing a first beamforming unit, a second beamforming unit or utilizing the first and second beamforming units. The first beamforming unit performs beamforming in the frequency domain and the second beamforming unit performs beamforming in the time domain. Moreover, in some embodiments, configuring 150, 160 (and 155, 165 explained below) involves/comprises configuring pre-coding/beamforming weights for transmission and the same or corresponding pre-coding/beamforming weights are then utilized for reception. Alternatively, configuring 150, 160 (and 155, 165 explained below) involves/comprises configuring pre-coding/beamforming weights for reception and the same or corresponding pre-coding/beamforming weights are then utilized for transmission. In some embodiments, the beamforming weight for each antenna unit i is calculated as B(i)=exp(j*Ci), wherein i is the antenna unit number, Ci is the phase for antenna unit number i, j is the imaginary unit, and exp is the exponential function. Alternatively, the beamforming weight for each antenna unit i is calculated as B(i)=A(i)*exp(j*Ci), wherein i is the antenna unit number, A is an amplitude function of the antenna unit number i, j is the imaginary unit, Ci is the phase for antenna unit number i, and exp is the exponential function.

In some embodiments, the method 100 comprises setting 120 the first duration of the first timer based on a reliability measure of the first and/or second channel characteristics. The setting 120 is performed at the earliest directly after the first and second characteristics has been obtained. The setting 120 is performed at the latest when an analysis of the channel is completed. In some embodiments, the setting 120 is performed when the channel is updated (or immediately/just after). Furthermore, in some embodiments, the reliability measure of the first and/or second channel characteristics is a time variation measure, such as an angle of arrival (AoA) time variation measure. Alternatively, or additionally, the reliability measure of the first and/or second channel characteristics is an angle of departure (AoD) time variation measure.

Furthermore, in some embodiments, the steps of obtaining 110, starting 130, checking 140, configuring 150, configuring 160 and optionally the step of setting 120 (all of the method 100) are performed by a physical, PHY, layer control/processing unit 600. In some embodiments, the PHY layer control/processing unit 600 is a baseband, BB, processor. The BB processor may be/comprises a channel/beamforming analyser. Alternatively, the PHY layer control/processing unit 600 is/comprises a channel/beamforming analyser. In these embodiments, the indication that a communication with the first remote TNode 802, 806 is to be performed is received from a higher layer processing unit, such as a media access control (MAC) layer (processing) unit or a radio resource control (RRC) layer (processing) unit.

Moreover, in some embodiments, the method 100 comprises obtaining 115 third and fourth channel characteristics for a radio channel between a second remote TNode 804, 808 and the MATARA 420, i.e., for a second radio channel. The third and fourth channel characteristics are in some embodiments, third and fourth radio channel characteristics, such as third and fourth spatio-temporal radio channel characteristics. Furthermore, in some embodiments, the third channel characteristics is non-line of sight (nLoS) channel characteristics, i.e., relates to nLoS paths and the fourth channel characteristics is line of sight (LoS) channel characteristics, i.e., relates to LoS paths. In some embodiments, the method 100 comprises setting 125 a second duration of a second timer based on statistics, such as reliability statistics, such as a reliability measure of the third and/or fourth channel characteristics. Alternatively, the second duration of the second timer is pre-set or has a default value. The setting 125 is performed at the earliest directly after the third and fourth characteristics has been obtained. The setting 125 is performed at the latest when an analysis of the channel (i.e., the radio channel between the second remote TNode 804, 808 and the MATARA 420) is completed. In some embodiments, the setting 125 is performed when the channel is updated (or immediately/just after). Moreover, in some embodiments, the method 100 comprises starting 135 the second timer. The second timer expires at the end of the second duration. The second duration follows (immediately after) the start of the second timer, i.e., the start of the second duration occurs at the same time as the start of the second timer. The method 100 comprises, in some embodiments, checking 145 if the second timer has expired, i.e., checking if the end of the second duration has been reached. The checking 145 is performed upon (at, just after, immediately after) reception of an indication that a communication with (e.g., a transmission to) the second remote TNode 804, 808 is to be performed. The method 100 comprises, in some embodiments, configuring 155 the MATARA 420 based on the fourth channel characteristics (without basing the configuring 150 on the third channel characteristics) if the second timer has expired. Furthermore, the method 100 comprises configuring 165 the MATARA 420 based on the third and fourth channel characteristics if the second timer is still running.

Moreover, in some embodiments, the steps of obtaining 115, starting 135, checking 145 configuring 155, configuring 165 and optionally the step of setting 125 (all of the method 100) are performed by a physical, PHY, layer control/processing unit 600. In some embodiments, the PHY layer control/processing unit 600 is a baseband, BB, processor. The BB processor may be/comprises a channel/beamforming analyser. Alternatively, the PHY layer control/processing unit 600 is/comprises a channel/beamforming analyser. In these embodiments, the indication that a communication with the second remote TNode 804, 808 is to be performed is received from a higher layer processing unit, such as a media access control (MAC) layer (processing) unit or a radio resource control (RRC) layer (processing) unit.

In some embodiments, the first remote TNode 802, 806 is a first WD 806. In these embodiments, the channel analyser obtains an identity (ID) for the first WD 806, e.g., via signalling between a scheduler and a channel analyser, and associate the obtained first and second channel characteristics with the first WD 806, and store information about ID and first and second channel characteristics in a memory. The ID may be a Radio Network Temporary Identifier (RNTI) associated with the first WD 806 or an ID associated with the RNTI, such as a scrambling code identity. As another example, the ID may be a Temporary International Mobile Subscriber Identity (TIMSI) or an International Mobile Subscriber Identity (IMSI). As yet another example, the ID may be a universally unique identifier (UUID) or a MAC address.

Furthermore, if the first remote TNode 802, 806 is a first WD 806, the method may further comprise checking 170 if the first WD 806 is connected to the MATARA 420. If the first WD 806 is not connected to the MATARA 420 the identity (ID) of the first WD 806 and the associated first and second (radio channel) characteristics are erased (thereby freeing up memory), whereas if the first WD 806 is connected to the MATARA 420 the memory is left intact. Moreover, in some embodiments, checking 170 comprises checking 172 if information (e.g., connection release information) related to a disconnection of the first WD 806 has been received from a scheduler. If information related to a disconnection of the first WD 806 has been received from a scheduler, the first WD 806 is considered/deemed not connected to the MATARA 420 and the identity (ID) of the first WD 806 and the associated first and second radio channel characteristics are erased. However, if no information related to a disconnection of the first WD 806 has been received from a scheduler, the first WD 806 is considered/deemed connected to the MATARA 420 and the memory is left intact.

Alternatively, checking 170 comprises starting 175 a third timer; checking 176 if the third timer has expired; if the third timer has expired, regarding/deeming 178 the first WD 806 as not connected (and thus erasing the ID of the first WD 806 and the associated first and second radio channel characteristics); and if the third timer is still running, regarding/deeming 179 the first WD 806 as connected (and thus leaving the memory intact). The third timer is, in some embodiments, started at the time of connection of the first WD 806 to the TNode 410/MATARA 420. Furthermore, the third timer expires at the end of the third duration and the third duration follows the start of the third timer, i.e., the start of the third duration occurs at the same time as the start of the third timer. In some embodiments the method 100 comprises setting 174 the third duration of the third timer. Alternatively, the third duration of the third timer is pre-set or has a default value. The third duration is, in some embodiments, set or pre-set to 1 hour (h) but may be any length of time from 1 millisecond (ms) to 127 years. In some embodiments, checking 170 comprises starting 175 a third timer; checking 176 if the third timer has expired and the steps 178, 179 etc. only if information related to a disconnection of the first WD 806 has not been received from a scheduler.

In some embodiments, after configuring 150, 155, 160, 165 or checking 170 has been performed, the method 100 may be repeated. As an example, the TNode 802, 806/WD 806 may wait until new first and second channel characteristics for a radio channel between the first remote TNode 802, 806/WD 806 and the MATARA 420 are obtained and then the method steps are repeated.

In some embodiments, obtaining 110 first and second channel characteristics comprises obtaining fifth channel characteristics. In these embodiments, the first channel characteristics may be non-line of sight (nLoS) channel characteristics, i.e., relates to nLos paths and the fifth channel characteristics may non-stable line of sight (LoS) channel characteristics, i.e., relates to non-stable LoS paths (with large, e.g., equal to or larger than a threshold, in direction/time) and the second channel characteristics may be stable line of sight (LoS) channel characteristics, i.e., relates to stable LoS paths (with small, e.g., smaller than a threshold, or no variation in direction/time). In these embodiments, a fourth timer may be started, the fourth timer expiring at the end of a fourth duration following the start of the fourth timer. The method 100 may then (instead of checking 140, configuring 150 and configuring 160) comprise upon reception of an indication that a communication with the first remote TNode 802, 806 is to be performed checking 140a if the first timer has expired and checking 140b if the fourth timer has expired. If both the first and fourth timers have expired, configuring 150a the MATARA 420 based on the second channel characteristics; if the first timer has expired, but the fourth timer is still running, configuring 160a the MATARA 420 based on the second and fifth channel characteristics; if the fourth timer has expired, but the first timer is still running, configuring 160b the MATARA 420 based on the first and second channel characteristics; and if both the first and fourth timers are still running, configuring 160c the MATARA 420 based on the first, second and fifth channel characteristics.

FIG. 1B illustrates a multi-antenna transmitter and receiver arrangement (MATARA) 420 according to some embodiments. In some embodiments, the MATARA 420 is comprised in a TNode 410. In some embodiments, the TNode 410 is a WD. I.e., in some embodiments, the TNode/WD 410 comprises the MATARA 420. The MATARA 420 (or the WD or the TNode 410) comprises a processing unit 600, a control unit or similar controlling circuitry. Furthermore, the processing unit 600 is connected or connectable to a plurality of transceivers 500, . . . , 507 directly or via one or more digital interfaces 400, . . . , 407. Moreover, in some embodiments, each transceiver 500, . . . , 507 is connected to one or more antenna units 700, . . . , 707. In some embodiments, the MATARA 420 comprises the transceivers 500, . . . , 507, the processing unit 600 and optionally the digital interfaces 400, . . . , 407 and/or the one or more antenna units 700, . . . , 707. Alternatively, in some embodiments, the MATARA 420 comprises the transceivers 500, . . . , 507, and optionally the digital interfaces 400, . . . , 407 and/or the one or more antenna units 700, . . . , 707 and the WD (or the TNode 410) comprises the processing unit 600. In some embodiments, the digital interfaces 400, . . . , 407 are comprised in a respective transceiver 500, . . . , 507). In some embodiments, the digital interfaces 400, . . . , 407 are comprised in the processing unit 600. The WD/TNode 410 is able/configurable/configured to communicate with (transmit to and/or receive from) the remote TNodes 802, 804, 806, 808 (via antenna units 700, . . . , 707 and transceivers 500, . . . , 507). Some of the TNodes 802, 804, 806, 808 are WDs 806, 808.

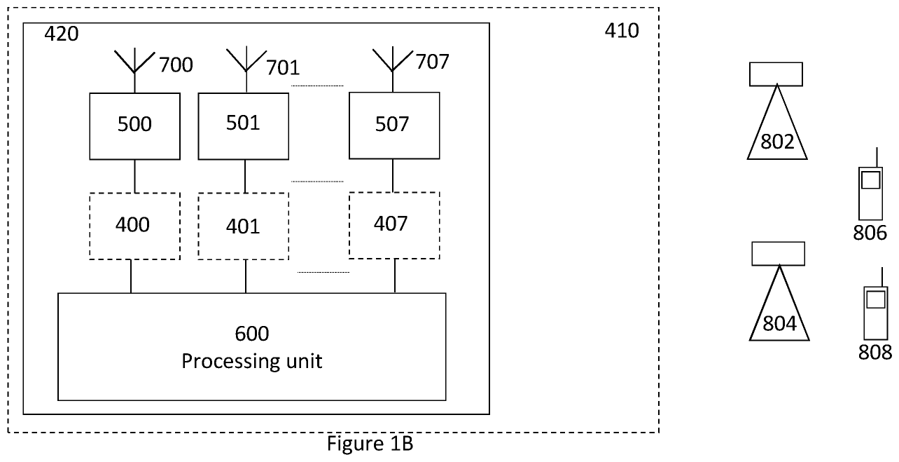

FIG. 2 illustrates method steps implemented in a WD, in a TNode, or in a multi-antenna transmitter and receiver arrangement (MATARA) 420 (or in a control unit or controlling circuitry comprised therein or associated therewith, e.g., a processing unit, and configured to control the MATARA 420 according to some embodiments. The MATARA 420 comprises controlling circuitry. Alternatively, a WD or a TNode 410 comprising the MATARA 420 comprises the controlling circuitry. In some embodiments, the controlling circuitry is (or comprises) the physical, PHY, layer control/processing unit 600 mentioned herein. The controlling circuitry causes or is configured to cause obtainment 210 of first and second channel characteristics for a radio channel between a first remote TNode 802, 806 and the MATARA 420. To this end, the controlling circuitry may be associated with (e.g., operatively connectable, or connected, to) a first obtainment unit (e.g., first obtaining circuitry, first obtainer or transceivers 500, 501, . . . , 515 with associated antenna units 700, 701, . . . , 715). Furthermore, the controlling circuitry causes or is configured to cause starting 230 of a first timer, the first timer expiring at the end of a first duration following the start of the first timer. To this end, the controlling circuitry may be associated with (e.g., operatively connectable, or connected, to) a first timer starting unit (e.g., first timer starting circuitry, first timer starter or the processing unit 600). Moreover, the controlling circuitry causes or is configured to cause checking 240 of whether the first timer has expired upon reception of an indication that a communication with the first remote TNode 802, 806 is to be performed. To this end, the controlling circuitry may be associated with (e.g., operatively connectable, or connected, to) a first checking unit (e.g., first checking circuitry, first checker, or the processing unit 600). The controlling circuitry causes or is configured to cause configuration 250 of the MATARA 420 based on (only) the second channel characteristics (and not based on the first channel characteristics) if the first timer has expired and configuration 260 of the MATARA 420 based on the first and second channel characteristics if the first timer is still running. To this end, the controlling circuitry may be associated with (e.g., operatively connectable, or connected, to) a first configurating unit (e.g., first configurating circuitry, a first configurer or the processing unit 600). In some embodiments, the controlling circuitry causes or is configured to cause obtainment 215 of third and fourth channel characteristics for a radio channel between a second remote TNode 804, 808 and the MATARA 420. To this end, the controlling circuitry may be associated with (e.g., operatively connectable, or connected, to) a second obtainment unit (e.g., second obtaining circuitry, second obtainer or transceivers 500, 501, . . . , 515 with associated antenna units 700, 701, . . . , 715). In some embodiments, the second obtainment unit is the first obtainment unit, i.e., the first and second obtainment units are the same unit. In some embodiments, the controlling circuitry causes or is configured to cause setting 220 of the first duration of the first timer based on a reliability measure of the first and/or second channel characteristics. To this end, the controlling circuitry may be associated with (e.g., operatively connectable, or connected, to) a first duration setting unit (e.g., first duration setting circuitry, first duration setter, or the processing unit 600). In some embodiments, the controlling circuitry causes or is configured to cause setting 225 of a second duration of a second timer based on a reliability measure of the third and/or fourth channel characteristics. To this end, the controlling circuitry may be associated with (e.g., operatively connectable, or connected, to) a second duration setting unit (e.g., second duration setting circuitry, second duration setter or the processing unit 600). Furthermore, in some embodiments, the controlling circuitry causes or is configured to cause starting 235 of a second timer, the second timer expiring at the end of a second duration following the start of the second timer. To this end, the controlling circuitry may be associated with (e.g., operatively connectable, or connected, to) a second timer starting unit (e.g., second timer starting circuitry, second timer starter or the processing unit 600). In some embodiments, the second timer starting unit is the first timer starting unit, i.e., the first and second timer starting units are the same unit. Moreover, in some embodiments, the controlling circuitry causes or is configured to cause checking 245 of whether the second timer has expired upon reception of an indication that a communication with the second remote TNode 804, 808 is to be performed. To this end, the controlling circuitry may be associated with (e.g., operatively connectable, or connected, to) a second checking unit (e.g., second checking circuitry, second checker or the processing unit 600). In some embodiments, the controlling circuitry causes or is configured to cause configuration 255 of the MATARA 420 based on the fourth channel characteristics (and not based on the third channel characteristics) if the second timer has expired and configuration 265 of the MATARA 420 based on the third and fourth channel characteristics if the second timer is still running. To this end, the controlling circuitry may be associated with (e.g., operatively connectable, or connected, to) a second configurating unit (e.g., second configurating circuitry, a second configurer or the processing unit 600). In some embodiments, the second configurating unit is the first configurating unit, i.e., the first and second configurating units are the same unit. In some embodiments, the controlling circuitry causes or is configured to cause checking 270 of if the first WD 806 is connected to the MATARA 420. If the first WD 806 is not connected to the MATARA 420 the identity (ID) of the first WD 806 and the associated first and second radio channel characteristics is erased, whereas if the first WD 806 is connected to the MATARA 420 the memory is left intact. To this end, the controlling circuitry may be associated with (e.g., operatively connectable, or connected, to) a third checking unit (e.g., third checking circuitry, third checker or the processing unit 600). In some embodiments, the controlling circuitry causes or is configured to cause checking 272 of if information related to a disconnection of the first WD 806 has been received from a scheduler. If information related to a disconnection of the first WD 806 has been received from a scheduler, the first WD 806 is considered/deemed not connected to the MATARA 420 and the identity (ID) of the first WD 806 and the associated first and second radio channel characteristics is erased. However, if no information related to a disconnection of the first WD 806 has been received from a scheduler, the first WD 806 is considered/deemed connected to the MATARA 420 and the memory is left intact. To this end, the controlling circuitry may be associated with (e.g., operatively connectable, or connected, to) a fourth checking unit (e.g., fourth checking circuitry, fourth checker or the processing unit 600). In some embodiments, the controlling circuitry causes or is configured to cause setting 274 of the third duration of the third timer. To this end, the controlling circuitry may be associated with (e.g., operatively connectable, or connected, to) a third duration setting unit (e.g., third duration setting circuitry, third duration setter or the processing unit 600). In some embodiments, the controlling circuitry causes or is configured to cause starting 275 of a third timer. To this end, the controlling circuitry may be associated with (e.g., operatively connectable, or connected, to) a third timer starting unit (e.g., third timer starting circuitry, third timer starter or the processing unit 600). In some embodiments, the third timer starting unit is the first timer starting unit, i.e., the first, second and third timer starting units are the same unit. In some embodiments, the controlling circuitry causes or is configured to cause checking 276 of if the third timer has expired. To this end, the controlling circuitry may be associated with (e.g., operatively connectable, or connected, to) a fifth checking unit (e.g., fifth checking circuitry, fifth checker or the processing unit 600). In some embodiments, the controlling circuitry causes or is configured to cause regarding/deeming 278 of the first WD 806 as not connected if the third timer has expired (and thus erasing the ID of the first WD 806 and the associated first and second radio channel characteristics). To this end, the controlling circuitry may be associated with (e.g., operatively connectable, or connected, to) a first deeming unit (e.g., first deeming circuitry, first deemer or the processing unit 600). In some embodiments, the controlling circuitry causes or is configured to cause if the third timer is still running, regarding/deeming 279 of the first WD 806 as connected if the third timer is still running (and thus leaving the memory intact). To this end, the controlling circuitry may be associated with (e.g., operatively connectable, or connected, to) a second deeming unit (e.g., second deeming circuitry, second deemer or the processing unit 600). In some embodiments, the second deeming unit is the first deeming unit, i.e., the first and second deeming units are the same unit.

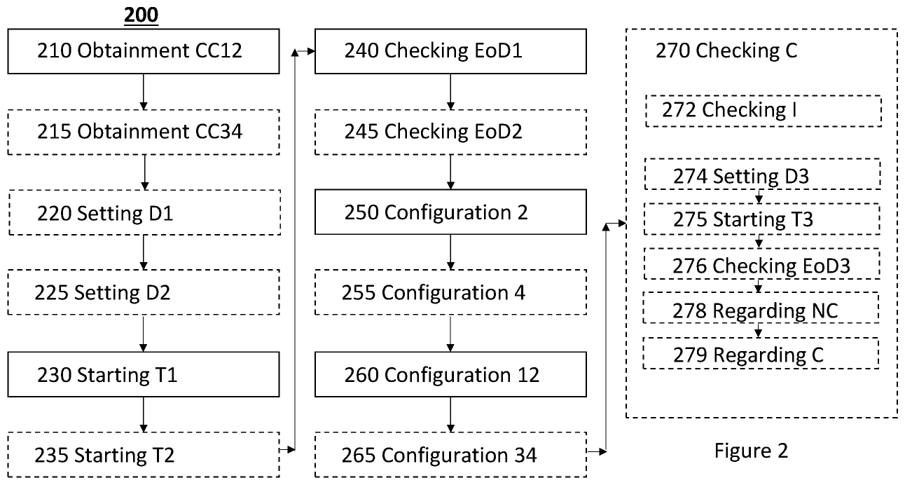

According to some embodiments, a computer program product comprising a non-transitory computer readable medium 300, such as a punch card, a compact disc (CD) ROM, a read only memory (ROM), a digital versatile disc (DVD), an embedded drive, a plug-in card, a random-access memory (RAM) or a universal serial bus (USB) memory, is provided. FIG. 3 illustrates an example computer readable medium in the form of a compact disc (CD) ROM 300. The computer readable medium has stored thereon, a computer program comprising program instructions. The computer program is loadable into a data processor (PROC) 320, which may, for example, be comprised in a computer 310 or a computing device or a control unit. When loaded into the data processor, the computer program may be stored in a memory (MEM) 330 associated with or comprised in the data processor. According to some embodiments, the computer program may, when loaded into and run by the data processor, cause execution of method steps according to, for example, the method illustrated in FIG. 1A, which is described herein. Furthermore, in some embodiments, there is provided a computer program product comprising instructions, which, when executed on at least one processor of a processing device, cause the processing device to carry out the method illustrated in FIG. 1A. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1A.

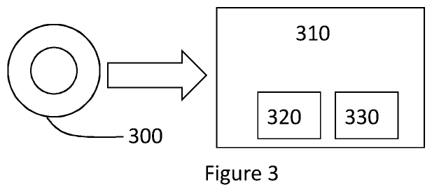

FIG. 4 illustrates an example gNodeB (gNB) architecture. A TNode 410 is/comprises a base station such as a gNB. The TNode 410 performs radio processing/beamforming, physical layer processing and/or higher layer processing. The higher layer (processor) receives data (e.g., data received from one or more WDs/UEs) from the physical layer (processor) and the physical layer (processor) receives WD ID data, reception and/or transmission configuration data from the higher layer (processor). The higher layer (processor) may handle mobility management, higher layer retransmission control, scheduling (of data packets to and from one or more UEs), communication with (e.g., one or more servers located in) the Internet and/or packet segmentation. The higher layer(s) may be a RRC layer and/or a MAC layer. The physical layer (processor) may handle channel estimation, equalizer, decoding, coding, fast Fourier transformation (FFT), inverse fast Fourier transformation (IFFT), and/or beamforming control. Furthermore, the TNode 410 may be connected to a first WD UE1 and/or a second WD UE2. Moreover, the TNode 410 may be connected to the Internet.

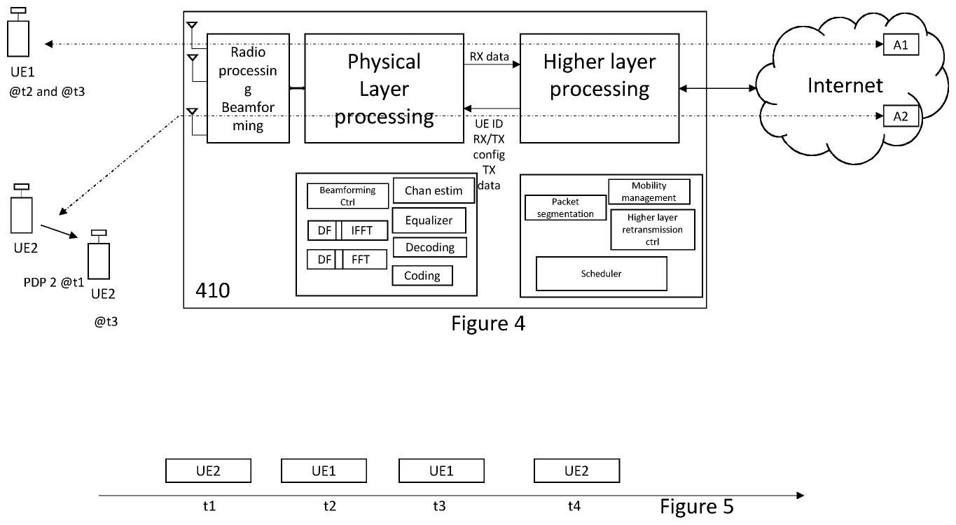

FIG. 5 is a schematic timing diagram illustrating scheduling of first and second wireless device according to some embodiments. More specifically, FIG. 5 illustrates that a timer has expired for the second WD UE2 the following/next time the UE2 is scheduled at time t4 (t4−t2>timer duration). Thus, it may be wise to only utilize the second channel characteristics for the second WD UE2 at time t4, e.g., since the first channel characteristics may not be valid/reliable at time t4. Furthermore, the first WD UE1 is scheduled with a time period smaller than the timer duration (t3−t2<timer duration) and hence both the first and the second channel characteristics is/may be utilized at time t3.

FIG. 6 illustrates an example gNodeB (gNB) architecture. A TNode 410 is/comprises a gNB. The TNode 410 performs radio processing/beamforming, physical layer processing and/or higher layer processing. The higher layer (processor) receives data (e.g., data received from one or more WDs/UEs) from the physical layer (processor) and the physical layer (processor) receives WD ID data, reception and/or transmission configuration data from the higher layer (processor). The higher layer (processor) may handle mobility management, higher layer retransmission control, scheduling (of data packets to and from one or more UEs), communication with (e.g., one or more servers located in) the Internet and/or packet segmentation. The higher layer(s) may be an RRC layer and/or a MAC layer. The physical layer (processor) may handle channel estimation, equalizer, decoding, coding, fast Fourier transformation (FFT), inverse fast Fourier transformation (IFFT), and/or beamforming control. Furthermore, the TNode 410 may be connected to a first WD UE1 and/or a second WD UE2. Moreover, the TNode 410 may be connected to the Internet. The TNode 410 (or a BB processor thereof) comprises a channel analyser. The physical layer (processor) comprises the channel analyser. Alternatively, or additionally, the higher layer (processor) comprises a/the channel analyser. As an example, if the physical layer (processor) comprises the channel analyser, the steps of the method 100 are performed by the physical layer (processor, e.g., a BB processor, e.g., the processing unit 600) and the indication that a communication with the first remote TNode 802, 806 is to be performed is received (by the physical layer [processor]) from a higher layer processing unit, such as a media access control, MAC, layer unit or a radio resource control, RRC, layer unit.

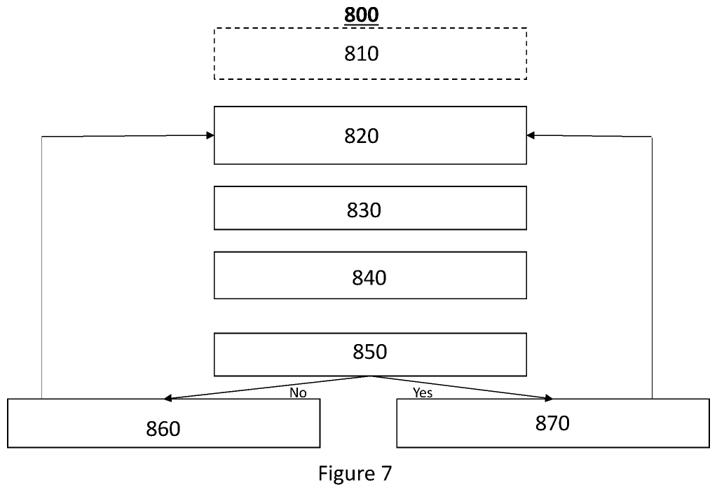

FIG. 7 is a schematic drawing illustrating method steps according to some embodiments. The method 800 may comprise obtaining 810 a first indication of transmission to or reception of data from a first WD/UE 806. Furthermore, the method comprises obtaining 820 first and second radio channel characteristics for a first WD 806. Moreover, the method comprises obtaining and starting 830 a (first) timer. The method 800 comprises obtaining 840 an indication of transmission to or reception of data from the first WD 806. Furthermore, the method 800 comprises checking 850 if the timer is expired (Yes/No). If the timer is expired (Yes), the method 800 comprises configuring 860 the MATARA 420 based on second radio channel characteristics and if the timer is still running (No), the method 800 comprises configuring 870 the MATARA 420 based on first and second radio channel characteristics.

After the configuring 860, 870 is performed, the method 800 may continue to obtaining 820 first and second radio characteristics, i.e., the one or more of the method steps 810-870 are repeated. In some embodiments, one or more of the steps of the method 800 is part of the method 100.

In some embodiments/aspects, a chip is provided (not shown). The chip comprises the PHY layer control/processing unit 600 and optionally one or more digital interfaces 400, . . . , 407 and/or optionally the plurality of transceivers 500, . . . , 507. Alternatively, the chip comprises the MATARA 420 and the MATARA 420 comprises the PHY layer control/processing unit 600. Moreover, in some embodiments, the first WD 806 comprises the chip.

### LIST OF EXAMPLES

### Example 1

A method (100) for a multi-antenna transmitter and receiver arrangement, MATARA, (420), the MATARA (420) comprisable in a transceiver node, TNode, (400) the method comprising:
obtaining (110) first and second channel characteristics for a radio channel between a first remote TNode (802, 806) and the MATARA (420);
starting (130) a first timer, the first timer expiring at the end of a first duration following the start of the first timer;
upon reception of an indication that a communication with the first remote TNode (802, 806) is to be performed checking (140) if the first timer has expired;
if the first timer has expired, configuring (150) the MATARA (420) based on the second channel characteristics; and
if the first timer is still running, configuring (160) the MATARA (420) based on the first and second channel characteristics.

### Example 2

The method of example 1, wherein the first channel characteristics is associated with a first set of channel taps and/or spatial directions, wherein the second channel characteristics is associated with a second set of channel taps and/or spatial directions, and wherein the first set of channel taps comprises more channel taps than the second set of channel taps.

### Example 3

The method of example 2, wherein one or more channel taps of the second set of channel taps are included in the first set of channel taps and wherein one or more of the channel taps of the first set of channel taps are not included in the second set of channel taps.

### Example 4

The method of any of examples 1-3, further comprising setting (120) the first duration of the first timer based on a reliability measure of the first and/or second channel characteristics.

### Example 5

The method of example 4, wherein the reliability measure of the first and/or second channel characteristics is an angle of arrival, AoA, or an angle of departure, AoD, time variation measure.

### Example 6

The method of any of examples 1-5, wherein the steps of obtaining (110), starting (130), checking (140), configuring (150), configuring (160) and optionally setting (120) are performed by a physical, PHY, layer control/processing unit (600), such as a baseband, BB, processor, and wherein the indication that a communication with the first remote TNode (802, 806) is to be performed is received from a higher layer processing unit, such as a media access control, MAC, layer unit or a radio resource control, RRC, layer unit.

### Example 7

The method of any of examples 1-6, further comprising:
obtaining (115) third and fourth channel characteristics for a radio channel between a second remote TNode (804, 808) and the MATARA (420);
optionally setting (125) a second duration of a second timer based on a reliability measure of the third and/or fourth channel characteristics;
starting (135) the second timer, the second timer expiring at the end of the second duration following the start of the second timer;
upon reception of an indication that a communication with the second remote TNode (804, 808) is to be performed checking (145) if the second timer has expired;
if the second timer has expired, configuring (155) the MATARA (420) based on the fourth channel characteristics; and
if the second timer is still running, configuring (165) the MATARA (420) based on the third and fourth channel characteristics.

### Example 8

The method of example 7, wherein the steps of obtaining (115), starting (135), checking (145), configuring (155), configuring (165) and optionally setting (125) are performed by a physical, PHY, layer control/processing unit (600), such as a baseband, BB, processor, and wherein the indication that a communication with the second remote TNode (804, 808) is to be performed is received from a media access control, MAC, layer unit or from a radio resource control, RRC, layer unit, such as a higher layer processing unit.

### Example 9

The method of any of examples 1-8, wherein the first remote TNode (802, 806) is a first wireless device (806), WD, wherein the method further comprises:
checking (170) if the first WD (806) is connected to the MATARA (420);
if the first WD (806) is not connected to the MATARA (420) erase the identity, ID, of the first WD (806) and the associated first and second radio channel characteristics; and
if the first WD (806) is connected to the MATARA (420) leave the memory intact.

### Example 10

The method of example 9, wherein checking (170) comprises:
checking (172) if information related to a disconnection of the first WD (806) has been received from a scheduler.

### Example 11

The method of example 9, wherein checking (170) comprises:
optionally setting (174) a third duration of a third timer;
starting (175) the third timer, the third timer expiring at the end of the third duration following the start of the third timer;
checking (176) if the third timer has expired;
if the third timer has expired, regarding (178) the first WD (806) as not connected; and
if the third timer is still running, regarding (179) the first WD (806) as connected.

### Example 12

A computer program product comprising a non-transitory computer readable medium (200), having stored thereon a computer program comprising program instructions, the computer program being loadable into a data processing unit (320) and configured to cause execution of the method of any of examples 1-11 when the computer program is run by the data processing unit (320).

### Example 13

A multi-antenna transmitter and receiver arrangement, MATARA, (420) comprising controlling circuitry configured to cause:
obtainment (210) of first and second channel characteristics for a radio channel between a first remote TNode (802, 806) and the MATARA (420);
starting (230) of a first timer, the first timer expiring at the end of a first duration following the start of the first timer;
upon reception of an indication that a communication with the first remote TNode (802, 806) is to be performed checking (240) of whether the first timer has expired;
if the first timer has expired, configuration (250) of the MATARA (420) based on the second channel characteristics; and
if the first timer is still running, configuration (260) of the MATARA (420) based on the first and second channel characteristics.

### Example 14

A transceiver node, TNode, (400) comprising a multi-antenna transmitter and receiver arrangement, MATARA, (420) and controlling circuitry configured to cause:
obtainment (210) of first and second channel characteristics for a radio channel between a first remote TNode (802, 806) and the MATARA (420);
starting (230) of a first timer, the first timer expiring at the end of a first duration following the start of the first timer;
upon reception of an indication that a communication with the remote TNode (802, 806) is to be performed checking (240) of whether the first timer has expired;
if the first timer has expired, configuration (250) of the MATARA (420) based on the second channel characteristics; and
if the first timer is still running, configuration (260) of the MATARA (420) based on the first and second channel characteristics.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method for a multi-antenna transmitter and receiver arrangement MATARA the MATARA comprisable in a transceiver node TNode the method comprising:
obtaining, by a physical PHY layer control/processing unit, first channel characteristics and second channel characteristics for a radio channel between a first remote TNode and the MATARA, wherein the first channel characteristics includes non-line of sight (nLoS) channel characteristics, and the second channel characteristics includes line of sight (LoS) channel characteristics;
starting, by the PHY layer control/processing unit, a first timer, the first timer expiring at the end of a first duration following the start of the first timer;
upon reception, from a higher layer processing unit, of an indication that a communication with the first remote TNode is to be performed checking, by the PHY layer control/processing unit, if the first timer has expired;
if the first timer has expired, configuring, by the PHY layer control/processing unit, the MATARA based on the second channel characteristics; and
if the first timer is still running, configuring, by the PHY layer control/processing unit, the MATARA based on the first channel characteristics and the second channel characteristics.

2. The method of claim 1, wherein the first channel characteristics is associated with a first set of channel taps, wherein the second channel characteristics is associated with a second set of channel taps, and wherein the first set of channel taps comprises more channel taps than the second set of channel taps.

3. The method of claim 2, wherein one or more channel taps of the second set of channel taps are included in the first set of channel taps and wherein one or more of the channel taps of the first set of channel taps are not included in the second set of channel taps.

4. The method of claim 1, further comprising setting the first duration of the first timer based on a reliability measure of the first channel characteristics and/or the second channel characteristics.

5. The method of claim 4, wherein the reliability measure of the first and/or second channel characteristics is an angle of arrival, AoA, or an angle of departure, AoD, time variation measure.

6. The method of claim 4, wherein the step of setting is performed by the PHY layer control/processing unit.

7. The method of claim 1, wherein the PHY layer control/processing unit is a baseband, BB, processor.

8. The method of claim 1, wherein the higher layer processing unit is a media access control, MAC, layer unit or a radio resource control, RRC, layer unit.

9. The method of claim 1, further comprising:
obtaining third channel characteristics and fourth channel characteristics for a radio channel between a second remote TNode and the MATARA;
setting a second duration of a second timer based on a reliability measure of the third channel characteristics and/or the fourth channel characteristics;
starting the second timer, the second timer expiring at the end of the second duration following the start of the second timer;
upon reception of an indication that a communication with the second remote TNode is to be performed checking if the second timer has expired;
if the second timer has expired, configuring the MATARA based on the fourth channel characteristics; and
if the second timer is still running, configuring the MATARA based on the third and fourth channel characteristics.

10. The method of claim 9, wherein the obtaining the third channel characteristics and fourth channel characteristics, starting the second timer, checking if the second timer has expired, configuring the MATARA based on the fourth channel characteristics, configuring the MATARA based on the third and fourth channel characteristics and setting the second duration are performed by a physical (PHY) layer control/processing unit, and wherein the indication that a communication with the second remote TNode is to be performed is received from a higher layer processing unit.

11. The method of claim 10, wherein the PHY layer control/processing unit is a baseband, BB, processor.

12. The method of claim 10, wherein the higher layer processing unit is a media access control (MAC) layer unit or a radio resource control, RRC, layer unit.

13. The method of claim 1, wherein the first remote TNode is a first wireless device (WD), wherein the method further comprises:
checking if the first WD is connected to the MATARA;
if the first WD is not connected to the MATARA, erase the identity (ID) of the first WD and the associated first channel characteristics and the associated second channel characteristics; and
if the first WD is connected to the MATARA, leave the memory intact.

14. The method of claim 13, wherein checking if the first WD is connected to the MATARA comprises:
checking if information related to a disconnection of the first WD has been received from a scheduler.

15. The method of claim 13, wherein checking if the first WD is connected to the MATARA comprises:
setting a third duration of a third timer;
starting the third timer, the third timer expiring at the end of the third duration following the start of the third timer;
checking if the third timer has expired;
if the third timer has expired, regarding the first WD as not connected; and
if the third timer is still running, regarding the first WD as connected.

16. (canceled)

17. A non-transitory computer-readable storage medium storing one or more programs configured to be executed by one or more processors of a processing device, the one or more programs comprising instructions which, when executed by the processing device, causes the processing device to carry out the method according to claim 1.

18. A multi-antenna transmitter and receiver arrangement, (MATARA) comprising a physical (PHY) layer control/processing unit configured to cause:
obtainment of first channel characteristics and second channel characteristics for a radio channel between a first remote TNode and the MATARA, wherein the first channel characteristics includes non-line of sight (nLoS) channel characteristics, and the second channel characteristics includes line of sight (LoS) channel characteristics;
starting of a first timer, the first timer expiring at the end of a first duration following the start of the first timer;
upon reception, from a higher layer processing unit, of an indication that a communication with the first remote TNode is to be performed checking of whether the first timer has expired;
if the first timer has expired, configuration of the MATARA based on the second channel characteristics; and
if the first timer is still running, configuration of the MATARA based on the first channel characteristics and the second channel characteristics.

19-20. (canceled)

21. The method of claim 1, wherein the second channel characteristics further includes stable nLoS channel characteristics and the first channel characteristics includes non-stable nLoS channel characteristics.

22. The method of claim 1, wherein the first channel characteristics includes first nLoS channel characteristics, the nLoS channel characteristics having a reliability measure lower than a reliability measure threshold, and the second channel characteristics includes second nLoS channel characteristics, the second nLoS channel characteristics having a reliability measure higher than a reliability measure threshold, and LoS channel characteristics.
